(19) United States
(12) Patent Application Publication
(10) Pub. No.: US 2026/0291956 A1
(43) Pub. Date: Sep. 24, 2026

(54) SYSTEM AND A METHOD FOR IMPLEMENTING SECURITY MEASURES IN AN AVIONICS SYSTEM

(71) Applicant: HONEYWELL INTERNATIONAL INC., Charlotte, NC (US)

(72) Inventor: Saravanakumar Gurusamy, Bangalore (IN)

(21) Appl. No.: 19/316,683

(22) Filed: Sep. 2, 2025

(30) Foreign Application Priority Data
Mar. 18, 2025 (IN) 202511024108

(51) Int. Cl. H04L 9/40

(52) U.S. Cl. CPC H04L 63/1416; H04L 63/1425; H04L 63/1433

(57) ABSTRACT

The present disclosure discloses an implementation of detailed security measures that continuously operate throughout an avionics system of an aircraft. In an embodiment, a plurality of security systems are implemented for actively monitoring potential cybersecurity threats and anomalies in the avionics system. In the event of a detected security issue, the avionics system promptly provides a notification and an alert to a flight crew as well as to a ground crew. This provides a clear guidance on the necessary next steps and corrective actions to be taken by them. According to some embodiment, in the event of the detected security issue, the avionics system voluntarily takes preventive actions to safeguard other systems from being affected. The disclosed framework facilitates timely responses to threats and ensures the safety and security of the aircraft.

### FIELD OF INVENTION

The present disclosure generally relates to a method in an avionics system. In particular, the present disclosure discloses the method and the system for implementing security measures in the avionics system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Avionics systems form the backbone of modern aircraft, integrating essential functionalities that range from navigation and communication to flight control and monitoring. These modern electronic systems enhance operational efficiency, improve safety, and enable advanced capabilities such as autopilot, weather tracking, and real-time data analysis. As the aviation industry continues to evolve, the integration of digital technologies and connectivity has become paramount in optimizing the performance of the aircraft and the experience of the user.

However, with the advancements, the avionics system is more prone to cybersecurity threats. As avionics systems become more interconnected and reliant on data-sharing and cloud services, they are increasingly vulnerable to cyberattacks. In order to address the cybersecurity issues in the context of avionics systems, the Radio Technical Commission for Aeronautics (RTCA) has provided the DO-326/DO-356A documents that provide guidelines and standards for addressing cybersecurity issues in the avionics systems. These documents are part of the broader set of guidelines related to the safety and security of airborne and ground-based systems.

FIG. 1 illustrates an integrated avionic security framework 100 of an avionics system. The integrated avionics security framework 100 depicts a ‘V’ process developed for a security architecture for the avionics system. The integrated avionic security framework 100 defines the security requirements that align with the operational and safety needs. The integrated avionic security framework 100 defines the relationship between various stages of development, from requirements definition to design, implementation, verification, and validation (VV&A). For example, as can be seen in FIG. 1, the left side and the right side of ‘V’ define the system requirements definition and detail the processes of integration, testing requirements, and the like. Further, the middle of the ‘V’ involves various levels of verification like aircraft verification and system verification.

FIG. 2 illustrates a security risk assessment process associated with an avionics system. FIG. 2 depicts the security risk assessment process 200 of evaluating potential security risks associated with aviation systems as described in the RTCA documents. The security risk assessment process 200 describes a structured approach to identify, analyse, and mitigate security vulnerabilities within the avionics system. The security risk assessment process 200 defines the scope of risk assessment for the architecture under consideration. For example, section 201 defines a process of threat condition identification and evaluation. Further section 203 defines a process of identifying an impact of the threat, and threat scenarios. Likewise, section 205 defines the process of security measures characterization. Further, the section 207 defines the process of level of threat evaluation. Thus, the security risk assessment process 200 describes the various security measures that need to be developed are identified, and implemented at the aircraft and system levels.

FIG. 3 illustrates security measures implemented in the avionics system as per the described standards. FIG. 3 depicts the security measures 300 applied during an attack on the avionics system. When the attack occurs, at levels 301, 303, and 305, the avionics system takes procedural security measures such as deterrent measures, preventive measures, detective measures, corrective measures, and recovery measures. Further, when the attack occurs, at levels 301, 303, and 305, the avionics system takes technical security measures such as deterrent measures, preventive measures, detective measures, and recovery measures.

Though, the RTCA documents offer a foundational framework for initiating the cybersecurity process, however, they remain at a high level, with specific security measures (such as the detection measures, the deterrence measures, and the recovery measures as disclosed above) delegated to connected module suppliers. Additionally, the RTCA documents provide no details for pilot action or maintenance actions. Further, the industry standards, including the DO-326/DO-356A documents, mandate the SAL3 requirements in the avionics systems. Therefore, there is an ongoing need to comply with the SAL3 requirements for the aircraft. However, this necessitates expensive hardware and software updates to data loader units, as well as the implementation of enhanced software development practices. For example, to upgrade the software development level (IDAL) of software components from DAL E to DAL A to align with the SAL3 requirements, will require costly hardware and software upgrades to the data loader units. In addition, there is an alarming increase in cyberattacks across the aviation industry, affecting both avionics and non-avionics systems. For example, targeted enterprise and operational platforms, such as ticketing and boarding processes are already at the potential risk of cyber threats which further may escalate to the aircraft and avionics domains.

Further, the emergence of Urban Air Mobility (UAM) and Unmanned Aerial Vehicles (UAVs) presents even greater challenges, as these autonomous aerial vehicles, which transport cargo and passengers without a pilot, are likely to face significant cybersecurity threats. The absence of a central authority (e.g. pilot) on these vehicles further complicates cybersecurity measures.

To address the above challenges, there is a need to implement robust security practices and measures that can be integrated into aircraft systems at the aircraft level to prevent malicious attacks while complying with the SAL3 requirements.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a method for implementing security measures in an avionics system of an aircraft. Other implementations will be or will become, apparent to one with skill in the art upon examination of the following figures and detailed description. It is intended that all such additional implementations be included within this description within the scope of the disclosure.

The present disclosure provides a method for implementing security measures in an avionics system of an aircraft. According to an embodiment, the method includes periodically monitoring a plurality of security systems deployed in the avionics system, wherein the plurality of security systems comprises one or more of a Cybersecurity Monitoring System (CMS), a File Integrity Monitoring System (FIMS), a Network Intrusion Detection System (NIDS), and a Malicious Input Detection System (MIDS). Further, the method includes detecting a threat in at least one security system among the plurality of security systems. Further, the method includes notifying an alert to at least one of a flight crew and a ground crew based on the threat. Further, the method includes performing one or more preventive actions in response to the detected threat. In an embodiment, the one or more preventive actions comprises isolating at least one of vulnerable files, vulnerable data, vulnerable networks, and vulnerable processes. Further, the one or more preventive actions comprises terminating at least one of the vulnerable files, the vulnerable networks, and the vulnerable processes. Further, the one or more preventive action comprises cross-validating contents of registry files and a master configuration file. Furthermore, the one or more preventive action comprises automatically switching to at least one of a reliable network and a reliable process. Further, the one or more preventive action comprises performing a soft rebooting of the vulnerable processes, and restoring original configurations of at least one of the vulnerable processes and the vulnerable networks.

According to a further embodiment, a system for implementing security measures in an aircraft is disclosed. In an embodiment, the system comprises a plurality of security systems having one or more processors, a memory, and one or more programs stored in the memory. In an embodiment, the one or more programs when executed by the one or more processors of the plurality of security system cause the one or more processors to detect a threat in at least one security system among the plurality of security systems, wherein the plurality of security systems includes one or more of a Cybersecurity Monitoring System (CMS), a File Integrity Monitoring System (FIMS), a Network Intrusion Detection System (NIDS), and a Malicious Input Detection System (MIDS). Further, the one or more processors are configured to notify an alert to at least one of a flight crew and a ground crew based on the threat. In an embodiment, the one or more processors are configured to perform one or more preventive actions in response to the detected threat. The one or more preventive actions comprises isolate at least one of vulnerable files, vulnerable data, vulnerable networks, and vulnerable processes; terminate at least one of the vulnerable files, the vulnerable networks, and the vulnerable processes; cross-validate contents of registry files and a master configuration file; automatically switch to at least one of a reliable network and a reliable process; perform a soft rebooting of the vulnerable processes, and restore original configurations of at least one of the vulnerable processes and the vulnerable networks.

According to yet further embodiment, a non-transitory computer-readable storage medium storing program instructions for implementing security measures in an avionics system of an aircraft is disclosed. In an embodiment, the non-transitory computer-readable storage medium storing program instructions when executed, perform the steps of periodically monitoring a plurality of security systems deployed in the avionics system, wherein the plurality of security systems comprises one or more of a Cybersecurity Monitoring System (CMS), a File Integrity Monitoring System (FIMS), a Network Intrusion Detection System (NIDS), and a Malicious Input Detection System (MIDS). Further, the non-transitory computer-readable storage medium performs the step of detecting a threat in at least one security system among the plurality of security systems. Further, the non-transitory computer-readable storage medium performs the step of notifying an alert to at least one of a flight crew and a ground crew based on the threat. Further, the non-transitory computer-readable storage medium performs the step of performing one or more preventive actions in response to the detected threat. In an embodiment, the one or more preventive actions comprises isolating at least one of vulnerable files, vulnerable data, vulnerable networks, and vulnerable processes. Further, the one or more preventive actions comprises terminating at least one of the vulnerable files, the vulnerable networks, and the vulnerable processes. Further, the one or more preventive action comprises cross-validating contents of registry files and a master configuration file. Furthermore, the one or more preventive action comprises automatically switching to at least one of a reliable network and a reliable process. Further, the one or more preventive action comprises performing a soft rebooting of the vulnerable processes, and restoring original configurations of at least one of the vulnerable processes and the vulnerable networks.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an integrated avionic security framework 100 of an avionics system;

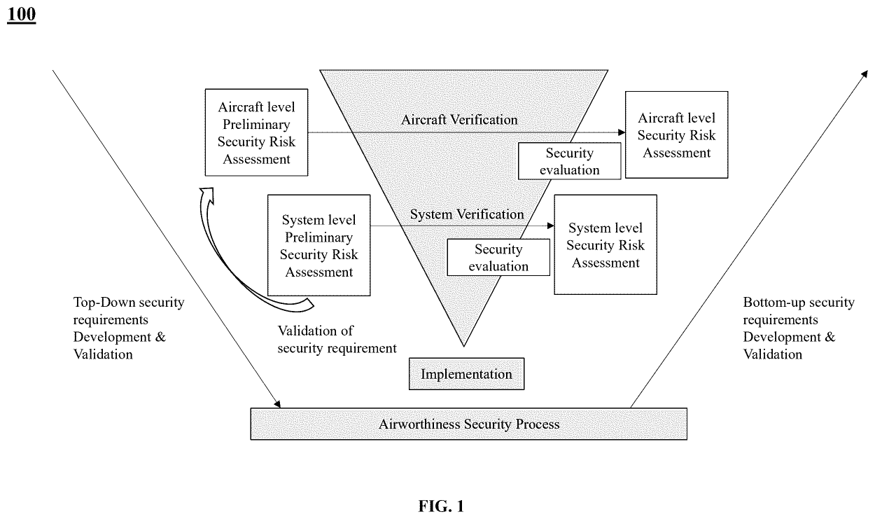

FIG. 2 illustrates a security risk assessment process associated with an avionics system;

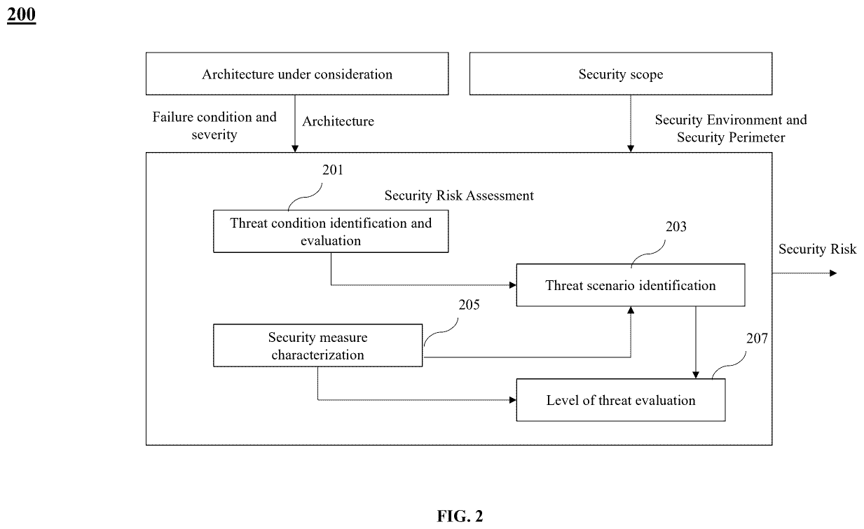

FIG. 3 illustrates security measures implemented in the avionics system as per the described standards;

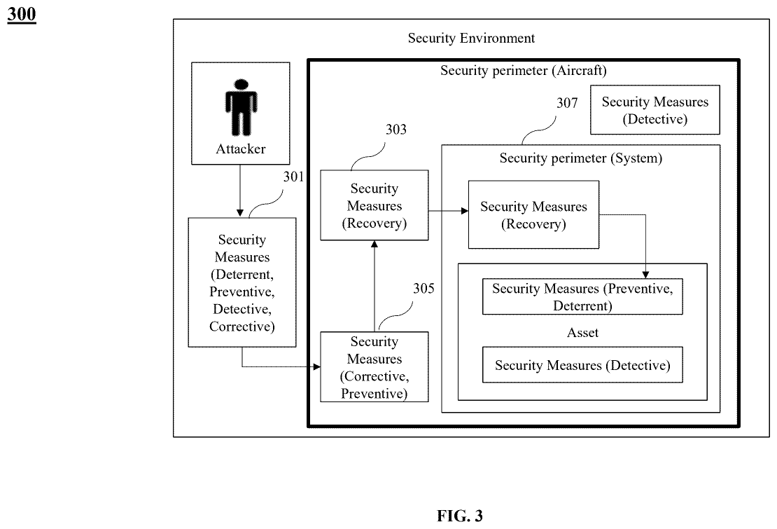

FIG. 4 illustrates an example environment of an air-to-ground communication system 400, according to an embodiment of the present disclosure;

FIG. 5 illustrates various components of avionics system, according to an embodiment of the present disclosure;

FIG. 6 illustrates a method 600 for detecting cyber threats by the CMS, according to an embodiment of the present disclosure;

FIG. 7 illustrates a method 700 for verifying an integrity of the file system by the FIMS, according to an embodiment of the present disclosure;

FIG. 8 illustrates a method 800 for detecting network intrusion by the NIDS, according to an embodiment of the present disclosure;

FIG. 9 illustrates a method 900 for detecting malicious input by an MIDS, according to an embodiment of the present disclosure;

FIG. 10 illustrates a method for implementing security measures in an avionics system of an aircraft, according to an embodiment of the present disclosure;

FIG. 11 illustrates an exemplary user interface (UI) for notifying the alert to the pilot or the crew, according to an embodiment of the present disclosure;

FIG. 12 illustrates an example of notifications displayed on the UI, according to an embodiment of the present disclosure; and

FIG. 13 illustrates a general block diagram of the avionics system, according to an embodiment of the present disclosure.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details. Further, the reference numerals for similar components, modules, units, and operation steps have been kept same for the ease of understanding.

Some embodiments of the present disclosure now will be described with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements.

According to an embodiment, an implementation of detailed security measures are designed and implemented that continuously operate throughout an avionics system of an aircraft. In an embodiment, a plurality of security systems are implemented for actively monitoring potential cybersecurity threats and anomalies in the avionics system. In the event of a detected security issue, the avionics system promptly provides a notification and an alert to a flight crew as well as to a ground crew. This provides a clear guidance on the necessary next steps and corrective actions to be taken by them. According to some embodiment, in the event of the detected security issue, the avionics system voluntarily takes preventive actions to safeguard other systems from being affected. The disclosed framework facilitates timely responses to threats and ensures the safety and security of the aircraft. A detailed implementation of the security measures deployed in the avionic systems will be explained in the forthcoming paragraphs.

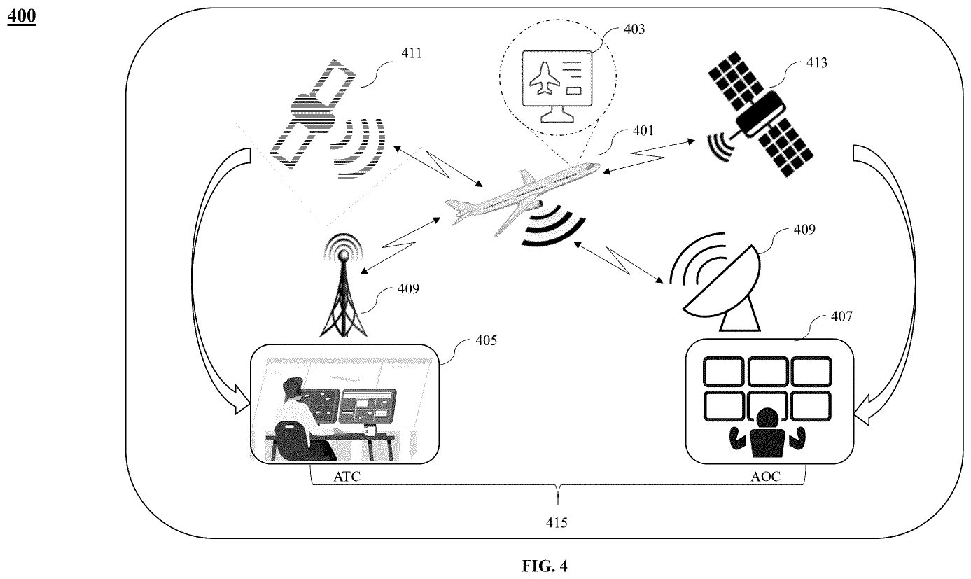

FIG. 4 illustrates an example environment of an air-to-ground communication system 400, according to an embodiment of the present disclosure. According to an example embodiment, the air-to-ground communication system 400 includes an aircraft 401 comprising an avionics system 403 and communicating with an Air Traffic Control (ATC) system 405, and an Airline Operation Control (AOC) system 407 via antenna stations 409. In an embodiment, the ATC system 405 and the AOC system 407 may be collectively referred to as a ground station system 415. According to some embodiments, the communication between the avionics system 403 and the ground station 413 is secured using encryption techniques, authentication protocols, and intrusion detection mechanisms. The data exchanges occur through satellite links, secured radio frequencies, or dedicated aviation networks, ensuring that only authorized entities have access to critical aviation data.

According to an embodiment, the ATC system 405 is a ground-based service that coordinates the movement of aircraft 401 in controlled airspace to ensure safe and efficient flight operations. The ATC system 405 manages the flow of air traffic around airports and throughout designated air routes. For example, the function of the ATC system 405 includes aircraft separation, flight clearance, traffic management, real-time communication between controllers and pilots, and the like. In an embodiment, the ATC system 405 operates by receiving data from the avionic system 403 such as navigation and communication equipment deployed in the aircraft 401. For example, aircraft transponders provide information such as position, altitude, and speed to ATC system 405, enabling controllers to track and manage air traffic effectively. In a non-limiting example, the data exchanged between the ATC system 405 and the avionics system 403 includes, but is not limited to, aircraft position data, planned routes, altitudes, estimated times of arrival, issued commands, weather information, and the like.

According to a further embodiment, the AOC system 407 is a centralized system that supports airline operations by managing various aspects such as scheduling, dispatching, resource allocation, and real-time monitoring of flight operations. The AOC system 407 ensures operational efficiency and safety for airlines. According to embodiment, the functions of the AOC system 407 include for example flight planning, real-time monitoring, resource management, coordination with ground services, and the like. In an embodiment, the avionics system 403 transmits vital information regarding flight status, which the AOC uses for operational decision-making.

According to a further embodiment, the aircraft 401 further communicates with satellites for fetching various data. In a non-limiting example, the satellites may include a Global Positioning System (GPS) satellite 411 and a Satellite Communication (SATCOM) system 413. The data exchanged between GPS satellite 411 and the aircraft 401 include, but are not limited to, positioning, timing, and navigation information, essential for accurate navigation. Meanwhile, the SATCOM system 413 facilitates communication between the aircraft 401 and ground entities, enabling the exchange of flight status, operational updates, real-time weather data, and the like. The forthcoming paragraph describes the avionics system 403 in detail.

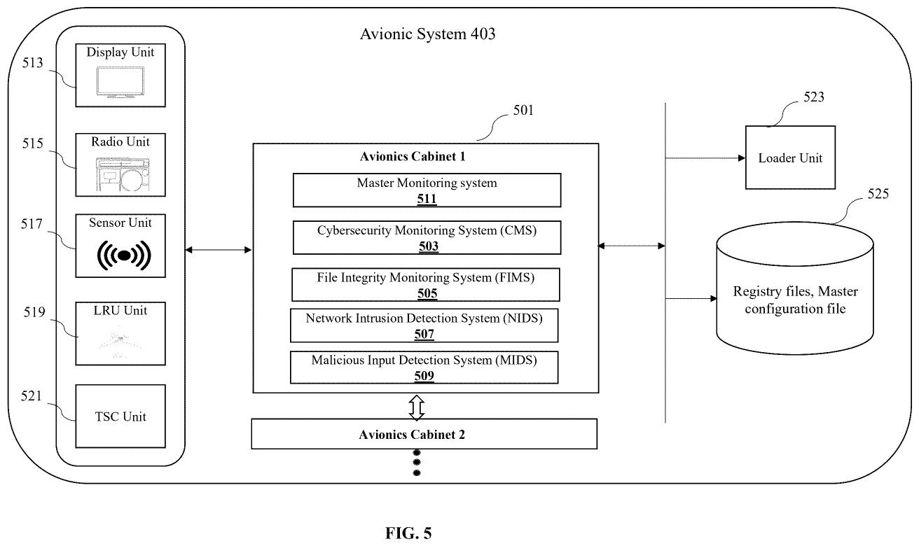

FIG. 5 illustrates various components of avionics system, according to an embodiment of the present disclosure. According to an embodiment, the avionics system 403 comprises a plurality of avionics cabinets for example, avionics cabinet 1, avionics cabinet 2 . . . avionics cabinet n. The plurality of avionics cabinets may be collectively and/or individually labelled as 501. According to an embodiment, the avionics cabinets 501 are specialized enclosures designed to house and protect various avionics equipment and systems used in the aircraft 401. The avionics cabinets include electronic systems that are used for an aircraft's operation, including navigation, communication, surveillance, and monitoring systems. For example, the avionics cabinets 501 housed electronic systems, such as a flight management system, a radio communication system, a navigation system, a radar system, a display system, a data processing system, and a cybersecurity system. In an embodiment, the avionics cabinets 501 are modular in designed for easy access, replacement, troubleshooting, and upgrades of individual components without requiring to removal of the entire cabinet.

According to an embodiment, each of the avionic cabinets includes a plurality of security systems in addition to the above-mentioned systems. As an example, the plurality of security systems includes a Cybersecurity Monitoring System (CMS) 503, a File Integrity Monitoring System (FIMS) 505, a Network Intrusion Detection System (NIDS) 507, and a Malicious Input Detection System (MIDS) 509. According to an embodiment, a Master Monitoring System (MMS) 511 deployed in each avionic cabinet, monitors the plurality of security systems. The plurality of security systems may be alternatively referred to as ‘security systems’, ‘monitoring systems’, ‘cyber monitors’, or ‘security monitors’ throughout the disclosure without departing from the scope of the invention.

In an embodiment, each avionic cabinet 501 is deployed with multiple applications hosted on multiple processors of the security systems and operates independently from each other. The security systems are the security monitors deployed as independent software modules, where each security system is hosted in separate modules to ensure isolation and security. In an embodiment, the CMS 503, the FIMS 505, the NIDS 507, the MIDS 509, and the MMS 511 are further equipped with specialized software that integrates with existing avionics software, allowing for centralized monitoring, reporting, and response functionalities. According to a further embodiment, each avionics cabinet 501 includes network interfaces that allow these security systems to connect to the aircraft's 401 avionics network. This connection facilitates data exchange and ensures the security systems continuously monitor network traffic and system activities in each avionics cabinet.

According to a further embodiment, each avionic cabinet 501 is further operatively coupled with various sources like a display unit 513, a radio unit 515, a sensor unit 517, a Line replaceable unit (LRU) unit 519, and a tactical support computer (TSC) unit 521.

In an embodiment, the display unit 513 provides visual information to the flight crew depicting data such as navigation maps, altitude, airspeed, aircraft system statuses, and alerts. The display unit 510 acts as the primary user interface for the pilot and crew, providing real-time alerts, cybersecurity warnings, and system status reports. For example, if the unauthorized data exchange is detected between the aircraft and an unknown ground station, the display unit 510 alerts the pilot and suggests mitigation strategies such as blocking communication with an unverified source.

According to a further embodiment, the radio unit 515 provides communication by transmitting and receiving voice and data messages between the aircraft 401 and the ground system 415, as well as other aircraft. According to a further embodiment, the sensor unit 517 collects various data inputs, including environmental measurements (e.g., temperature, pressure, and wind speed) and aircraft performance metrics (e.g., engine data and altitude). According to a further embodiment, the Line Replaceable Unit (LRU) 519 provides specialized functions such as avionics processing or auxiliary system control. The LRU 519 provides operational data regarding system health and performance, ensuring that avionics systems receive timely updates and alerts for maintenance needs. According to a yet further embodiment, the TSC Unit 521 acts as a central processing platform for tactical data management, providing critical information such as mission planning data, threat assessments, and target tracking.

In an implementation, due to the varying levels of importance among different security systems, the security systems are designed with differing degrees of rigor. For example, some security systems may be developed to Level A standards to meet Safety Assurance Level 3 (SAL3) requirements, while others will adhere to Level C standards. This multi-layered approach to deployment ensures that the security monitors are robust, reliable, and capable of effectively protecting the system against various threats.

According to a further embodiment, the each security systems is further connected with a loader unit 523 and a database 525. In an embodiment, the loader unit 523 provides functionalities such as software updates, data upload and download, configuration management, diagnostics, troubleshooting, aid in standardized communication, secure access control, and the like.

According to an embodiment, the database 525 is a centralized database that includes a registry file and a master configuration files. In a non-limiting example, the registry file includes information related to system settings, user profiles, installed software information, executable files, version numbers, license information, user permissions, access controls, policies to secure the system and applications, settings that determine how specific file types are handled by applications, default programs for opening certain file formats, boot-up software's, enabling/disabling of specific features of the software/operating system, and the like. According to some embodiment, the registry file further maintains records of authorized entities, their authentication credentials, and access permissions for specific data and system resources. The registry file includes details such as user identities, cryptographic keys, digital certificates, role-based access controls (RBAC), and predefined permissions that dictate what data or system functions each entity can access. In an embodiment, the security registry is continuously updated to reflect changes in personnel, revoked credentials, and emerging cyber threats, ensuring robust protection against unauthorized access, data breaches, and malicious intrusions. Further, the registry file supports multi-factor authentication (MFA) and real-time monitoring to enhance overall security.

According to a further embodiment, the master configuration files are used by software applications to define their settings and operational parameters. As an example, the master configuration files can be in various formats, such as JSON, or XML. In an embodiment, the master configuration files include data related to application settings, GUI settings, logging levels, operational modes, database connection details, server addresses, database names, user credentials, connection pooling options, IP addresses, IP ports, IP protocols to be used for communication, resource paths, flag settings, and the like. The forthcoming paragraphs will explain the brief functioning of each security monitor.

In an embodiment, the MMS 511 monitors the CMS 503, the FIMS 505, the NIDS 507, and the MIDS 509 to detect a threat in it. Further, the MMS 511 may take one or more preventive actions in response to the detected threat. According to some embodiments, the avionics system may operate in a master-slave configuration where one of the security systems on power-up may act as a master monitoring system, and the rest of the security system may act as a slave to the master monitoring system. According to an embodiment, the independent monitors i.e. the CMS 503, the FIMS 505, the NIDS 507, and the MIDS 509 check various parameters and functions to ensure they comply with the agreed design. Accordingly, the CMS 503, the FIMS 505, the NIDS 507, and the MIDS 509 validate system operations, behavior, and data.

According to an embodiment, the threat detected by the CMS 503 module, can be an unauthorized process execution and an unauthorized dataflow. In an implementation, the CMS 503 periodically monitors the data exchange between a plurality of processes, an execution of scheduled processes associated with the plurality of security systems, and the registry files to detect the threat. For example, the registry files manage an execution time of every process on various processors. Thus, the registry files can be periodically checked to verify if an unauthorized process is executing on a given processor. In yet further example, the registry files manage data produced on the avionics data bus and the data exchange between processes. Accordingly, the registry file is used to validate if unauthorized data is produced or exchanged on an aircraft network.

Further, in order to perform the unauthorized process, an intruder is most likely to tamper with the registry files so as to allow unauthorized execution or data exchange. Therefore, the CMS 503 periodically validates the registry files. According to an embodiment, the CMS 503 can periodically validate the registry files by performing an on-board validation and a ground system validation. In an implementation, during the on-board validation, each system or process cross-validate the content of the registry file with all other instances. In an embodiment, the CMS 503 additionally performs the ground system validation by validating the contents of the registry file with a ground system of the ground station 415. This ensures that a complete corruption of the registry files on the aircraft 401 is still detected by the ground system. According to a further embodiment, upon detecting a threat, the CMS 503 notifies the alert to the flight crew, the ground crew, or the MMS 511. According to an embodiment, the MMS 511 may take the one or more preventive actions. In an alternate embodiment, the CMS 503 may also take the one or more preventive actions. For example, in case the threat is detected, the CMS 503 may isolate/terminate at least one of the vulnerable files, vulnerable data, vulnerable networks, and vulnerable processes.

According to an embodiment, the FIMS 505 verifies the integrity of file contents of a plurality of files associated with the plurality of security systems. In an implementation, the FIMS 505 periodically monitors the file contents of the plurality of files associated with the plurality of security systems. Further, the FIMS 505 validates the file contents using the master configuration files present in the database 525. According to an embodiment, the master configuration file contains details of all authorized files and their associated CRC (Cyclic Redundancy Check) values. In an embodiment, the master configuration files serve as a registry of trusted files, ensuring that only those files are allowed to be hosted and executed on the avionics system 403. An example of a listing of authorized files in the master configuration files is depicted in Table 1.

TABLE 1
Avionics Cabinet 1

| | Golden CRC |
|---|---|
| Processor 1 Files: | |
| agmtbx.exe | 016CFAF1 |
| agmwx.exe | 0F7653E8 |
| appintfc.dll | 58F594FC |
| ar429.dll | AC2876ED |
| ccdkbd.dll | 981C2E36 |
| cltintfc.dll | 4D397EC3 |
| Processor 2 Files: | |
| cpumon.dll | 799717A7 |
| crctest.hit | A65D6E86 |
| dispreg.dll | CC0F9B31 |
| efs.init | 6D3EADFB |
| event.dll | 6AF2FF01 |
| fault.dll | E1DF37E6 |
| glf.dll | 0ED9C495 |
| glwx.dll | 6FD95092 |

As can be seen in the table 1, the master configuration files maintains a record of the authorized files along with the CRC values. According to an embodiment, the FIMS 505 verifies that all files present on the avionics system 403 matches the authorized files listed in the master configuration file, including their CRC values. Further, any discrepancies or unauthorized files are flagged for further investigation. In an embodiment, as a preventive action, the affected module may be shut down. Additionally, the registry file undergoes independent validation by performing on-board validation and ground system validation. This dual-validation (in air and on the ground) approach ensures that the registry files remain uncompromised and any attempts to tamper with the file system are promptly detected and addressed. By implementing these measures, the avionics system maintains a high level of security and reliability, preventing unauthorized files from being executed and ensuring the integrity of the authorized files.

According to an embodiment, based on the validation, if the FIMS 505 detects at least one of the unauthorized files and discrepancies in the file contents as the threat, then the FIMS 505 provides the information related to the detected threat for notifying the alert to the ground crew, the flight crew, or the MMS 511. Further, in case the threat is detected in the FIMS 505 or the MMS 511 may isolate or terminate the vulnerable files or the related modules. According to an embodiment, the MMS 511 may take the one or more preventive actions. In an alternate embodiment, the FIMS 505 may also take the one or more preventive actions.

According to an embodiment, the NIDS 507 detects the unauthorized network activity in the avionics system 403. As an example, the unauthorized network activity may be an unauthorized data request, an unauthorized access request, an unauthorized new device connection request, and the like. In general, each module within the avionics system is assigned with a fixed IP address. The details of an authorized IP address are provided in the master configuration file. This allows precise monitoring and control. Therefore, if a cybersecurity attack originates from an unauthorized IP address, it can be detected by cross-referencing in the master configuration file that contains a list of the authorized IP addresses. Table 2 illustrates an example of approved network devices with authorized IP addresses.

TABLE 2

| Avionics 1 Cabinet | |
|---|---|
| Avionics 1 Cabinet - SLOT 7 - VIDEO | 12.68.1.12 |
| Avionics 1 Cabinet - SLOT 5 - AGM 1 | 12.68.1.33 |
| Avionics 1 Cabinet - SLOT 3 - PROC 5 | 12.68.1.24 |
| Avionics 1 Cabinet - SLOT 2 - AGM 3 | 12.68.1.15 |
| Avionics 1 Cabinet - PROC 11 | 12.68.1.6 |
| Avionics 1 Cabinet - SLOT 8 - No Connect | None |
| Avionics 1 Cabinet - SLOT 6 - Spare | None |
| Avionics 1 Cabinet - SLOT 4 - No Connect | None |
| Avionics 1 Cabinet - SLOT 1 - No Connect | None |
| Avionics 1 Cabinet - SLOT 9 - No Connect | None |
| Avionics 1 Cabinet - SLOT 10 - No Connect | None |
| Avionics 1 Cabinet - SLOT 11 - No Connect | None |
| Avionics 1 Cabinet - SLOT 12 - No Connect | None |
| Avionics 1 Cabinet - SLOT 13 - Spare | None |
| Avionics 1 Cabinet - SLOT 14 - No Connect | None |
| Avionics 1 Cabinet - SLOT 15 - No Connect | None |
| Avionics 1 Cabinet - SLOT 16 - No Connect | None |
| Avionics 2 Cabinet - Network Card 3 | 12.68.3.1 |
| Avionics 2 Cabinet - SLOT 5 - GATEWAY I/O 3 | 12.68.3.11 |

As can be seen from the Table 2, the approved network devices along with their IP address is provided in the master configuration file. In an embodiment, along with the IP address, the list also provide hardware details like available slots, type of network device and the like.

Thus, any deviation from the authorized list can be an indication of the authorized network activity and hence are promptly notified to the flight crew, the ground crew, or the MMS 511. This cross-referencing ensures that any deviation from the authorized list is promptly identified. In the event of a detected cyber-attack, the NIDS 507 or the MMS 511 take one or more preventive actions like isolating or killing the sub-network to mitigate the impact and prevent the spread of the attack to other modules. Further, the NIDS 507 maintains a log to record the details of the unauthorized activity. The log serves as a critical resource for post-incident analysis and future prevention strategies. Furthermore, as the ground crew is also immediately notified of the unauthorized activity, this helps to take the one or more preventive actions to mitigate it. This notification allows for a coordinated response and ensures that all relevant personnel are aware of the security breach and can take appropriate actions to secure the avionics system.

In an embodiment, the MIDS 509 detects a malicious data injection in the avionics system 403. The malicious data can be the data when injected can lead to the tampering of the original data. For example, the malicious data could be injected into the avionics system to provide incorrect information, such as an incorrect pitch angle in the Inertial Reference System (IRS). In such a case, a cybersecurity attack was performed on the critical IRS unit that is providing catastrophic data to the flight crew. In an embodiment, the MIDS 509 validates whether the data received from one source is similar to the data received from other sources. For example, Ground Proximity Warning Function (EGPWF) module outputs an altitude that may not correlate within a certain threshold to the Air Data System (ADS) altitude and GPS altitude. In such a case, if MIDS 509 detects a discrepancy in the received data as the threat, then the MIDS 509 or MMS 511 notifies the alert to at least one of the ground crew and the flight crew. According to an embodiment, the MMS 511 may take the one or more preventive actions. In an alternate embodiment, the MIDS 509 may also take the one or more preventive actions.

In an embodiment, upon detecting a threat, the security systems or the MMS 511 take one or more preventive actions. According to an embodiment, the one or more preventive actions include, but are not limited to, the following:
isolating at least one of vulnerable files, vulnerable data, vulnerable networks, and vulnerable processes,
terminating at least one of the vulnerable files, the vulnerable networks, and the vulnerable processes,
cross-validating contents of registry files and a master configuration file,
automatically switching to at least one of a reliable network and a reliable process,
performing a soft rebooting of the vulnerable processes, and
restoring original configurations of at least one of the vulnerable processes and the vulnerable networks.

For illustrative purposes, consider an example scenario in which a security system detects that a processor module hosting the Enhanced Ground Proximity Warning Functions (EGPWF) has been compromised. In accordance with the disclosed methodology, the security system dynamically executes preventive actions by reassigning the priority source to the alternative EGPWF instance. Similarly, in another example scenario consider that I/O module that subscribes to data from the Inertial Reference System 1 (IRS1) is identified as potentially compromised, then the security system automatically redirects the pilot source to another reliable source for example either Inertial Reference System 2 (IRS2) or Inertial Reference System 3 (IRS3) to mitigate the risk of disseminating misleading information. Furthermore, an alert or a notification can be issued on the display unit 513 to ensure that the flight crew remains adequately informed of the situation.

In an example scenario, consider that the security system detects that a module is currently executing unauthorized software (for example, compromised software that manipulates data). In such a scenario, the security system may perform a soft reboot of the affected modules. This preventive action facilitates the removal of the unauthorized application from memory, thereby terminating its execution. Consequently, the perpetrator will be required to undergo an extensive reconfiguration process to relaunch the application, thereby granting the security measures additional time to identify and neutralize the compromised interface.

In a further illustrative example, if the security system detects that a specific module has been compromised (for instance, through the presence of additional files, unauthorized external access to files, or alterations to existing files), a provision shall be made for the flight crew to restore the module to its original configuration. Further, the relevant contents retain a secure copy of the original image, which shall be utilized for restoration if the module is deemed potentially compromised. Furthermore, options for an automatic system restoration process as a preventive action are also made available. Additionally, features such as Secure Boot may be implemented to ensure that the appropriate image files are loaded during the restoration process.

In a further illustrative example, consider an event that the security measures detect an unauthorized user entry on any aircraft-level modules, the notification is provided to the flight crew, or a Crew Alerting System (CAS) message can be displayed to notify the relevant parties of the situation as the preventive actions. This protocol ensures that the flight crew, the ground crew, and technicians are made aware of a potential security threat. Such a measure may be activated in circumstances where the cybersecurity monitoring systems identify a potential attack, though with a low probability of it being an actual attack. In these instances, providing notification to the pilot crew and the ground crew serves to alert them to the potential threat, enabling them to take an appropriate action. This allows the flight crew and the ground crew to maintain vigilance and implement necessary precautions, even in the absence of immediate confirmation of the threat. By keeping all related personnel informed, the avionics system significantly enhances overall safety and security, facilitating timely and informed decision-making to mitigate any potential risks. The forthcoming paragraphs will describe the methods performed by each of the security systems.

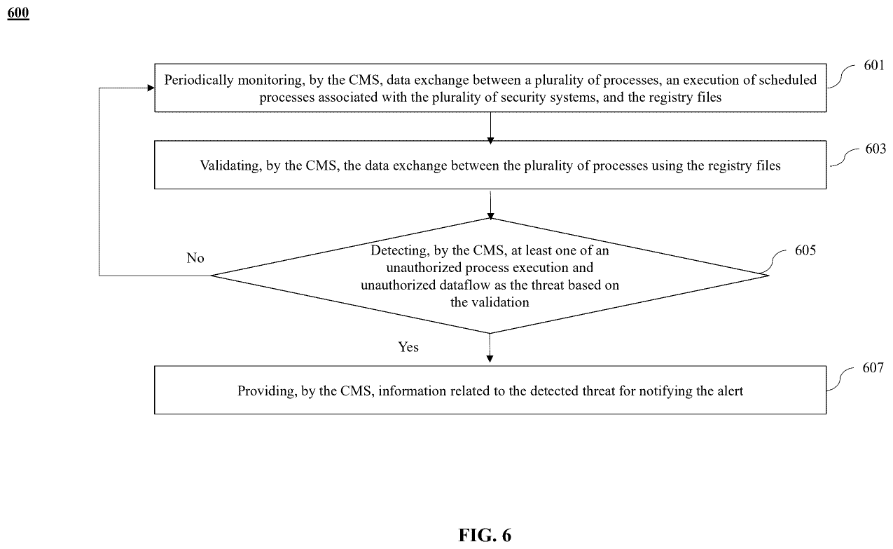

FIG. 6 illustrates a method 600 for detecting cyber threats by the CMS, according to an embodiment of the present disclosure. In an embodiment, the CMS 503 is uniquely designed hardware or software that is integrated within the avionics system 403. According to some embodiment, the functions of the CMS 503 can be performed by one or more processors. According to some embodiments, some functions of the CMS 503 may be deployed and developed with AI-powered solutions for performing specific tasks.

In an embodiment, as explained above various data are exchanged between processes that are deployed within each module, security systems, and the ground system. Accordingly, at step 601, CMS 503 periodically monitors the data exchange between the plurality of processes, the execution of scheduled processes associated with the plurality of security systems, and the registry files. Further, at step 603, the CMS 503 validates the data exchange between the plurality of processes using the registry files. As explained above, the registry files include the details of authorized entities that can exchange the data with the avionics systems. Further, the registry files also include the details of allowable entities and permission policies. Thus, when the data is exchanged between any of the plurality of processes, the CMS 503 validates it by checking the registry files.

Further, in an embodiment, at step 605, the CMS 503 detects whether at least one of the unauthorized process execution and the unauthorized dataflow is the threat based on a result of the validation. For example, during the validation, the CMS 503 may find that some unauthorized process execution or some unauthorized dataflow event has occurred, then in that case, at step 607, the CMS 503 provides information related to the detected threat for notifying the alert. According to an embodiment, the information related to the detected threat may be provided to the MMS 511. Further, the MMS 511 perform the one or more preventive actions in response to the detected threat and also notifies about the alert to at least one of the flight crew and the ground crew.

According to some embodiment, the CMS 503 may perform the one or more preventive actions in response to the detected threat. Further, the CMS performs the one or more preventive actions in response to the detected threat and also notifies about the alert to at least one of the flight crew and the ground crew.

For example, in case a cyberattack is being detected then the CMS 503 may isolate/terminate at least one of the vulnerable files, vulnerable data, vulnerable networks, and vulnerable processes. Further, the CMS 503 or the MMS 511 may cross-validate the contents of registry files with the ground system.

According to an embodiment, at step 605, if the CMS 503 fails to detect any unauthorized process execution and unauthorized dataflow, then the CMS 503 continues to perform the step 601.

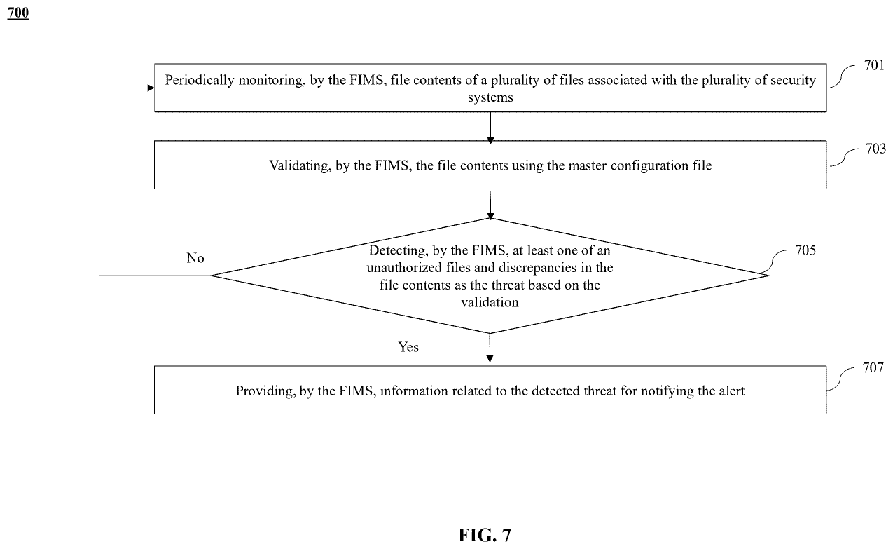

FIG. 7 illustrates a method 700 for verifying an integrity of the file system by the FIMS, according to an embodiment of the present disclosure. In an embodiment, the FIMS 505 is uniquely designed hardware or software that is integrated within the avionics system 403. According to some embodiment, the functions of the FIMS 505 can be performed by one or more processors. According to some embodiments, some functions of the FIMS 505 may be deployed and developed with AI-powered solutions for performing specific tasks.

According to an embodiment, at step 701, the FIMS 505 periodically monitors file contents of a plurality of files associated with the plurality of security systems. Further, at step 703, the FIMS 505, validates the file contents using the master configuration file. As explained above, the master configuration file includes the list of authorized files along with the CRC values. Thus, during the event of the intrusion, the contents of the file or the CRC values may be tampered. Thus, the FIMS while monitoring periodically validates the file contents by matching it with the list in the master configuration file.

According to a further embodiment, at step 705, the FIMS 505, detects whether there is at least one of an unauthorized file and whether there are any discrepancies in the file contents which can be a potential threat based on the result of the validation. In case a result of the validation results lead to the threat then, in that case, at step 707, the FIMS 505 provides information related to the detected threat for notifying the alert. According to an embodiment, the information related to the detected threat may be provided to the MMS 511. Further, the MMS 511 performs the one or more preventive actions in response to the detected threat and also notifies about the alert to at least one of the flight crew and the ground crew.

According to some embodiment, the FIMS 505 may perform the one or more preventive actions in response to the detected threat. Further, the FIMS 505 performs the one or more preventive actions in response to the detected threat and also notifies about the alert to at least one of the flight crew and the ground crew.

For example, in case a compromised file is being detected then the FIMS 505 may isolate or delete at least one of the vulnerable files, vulnerable data, vulnerable networks, and vulnerable processes. Further, the FIMS 505 or the MMS 511 may cross-validate the contents of the master configuration file with the ground system.

According to an embodiment, at step 705, if the FIMS 505 fails to detect any unauthorized process execution and unauthorized dataflow, then the FIMS 505 continues to perform the step 701.

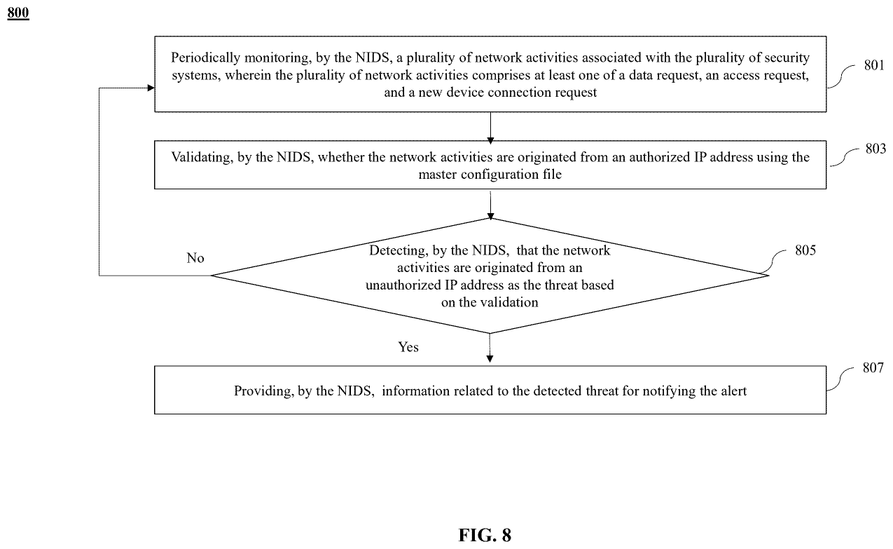

FIG. 8 illustrates a method 800 for detecting network intrusion by the NIDS, according to an embodiment of the present disclosure. In an embodiment, the NIDS 507 is uniquely designed hardware or software that is integrated within the avionics system 403. According to some embodiment, the functions of the NIDS 507 can be performed by one or more processors. According to some embodiments, some functions of the NIDS 507 may be deployed and developed with AI-powered solutions for performing specific tasks.

According to an embodiment, the avionics system 403 may receive various requests to access data, modules, processes, devices, and the like. Further, the avionics system 403 may also receive a connection request for connecting any modules or processes with a new device. However, the aforesaid network activities can be unauthorized.

In an embodiment, at step 801, the NIDS 507 periodically monitors a plurality of network activities associated with the plurality of security systems. Further, at step 803, the NIDS 507 validates whether the network activities are originated from an authorized IP address using the master configuration file. Generally, the cybersecurity attack originates from an unauthorized IP address. Thus, any request or activity that originates from a different IP address that are not defined or logged in the master configuration file can lead to an intrusion in the network.

Further, as explained above, the master configuration file includes a list of authorized network devices along with their fixed IP address. Accordingly, the NIDS 507 while monitoring periodically validates the IP address by matching it with the list in the master configuration file.

According to a further embodiment, at step 805, the NIDS 507 detects whether the network activities are originated from an unauthorized IP address as the threat based on the validation. In a case, a result of the validation leads to the threat where the NIDS detects that network activities are originated from an unauthorized IP address then, in such a scenario, at step 807, the NIDS 507 provides information related to the detected threat for notifying the alert. According to an embodiment, the information related to the detected threat may be provided to the MMS 511. Further, the MMS 511 performs the one or more preventive actions in response to the detected threat and also notifies about the alert to at least one of the flight crew and the ground crew.

According to some embodiment, the NIDS 507 may perform the one or more preventive actions in response to the detected threat. Further, the NIDS 507 performs the one or more preventive actions in response to the detected threat and also notifies about the alert to at least one of the flight crew and the ground crew.

For example, in case an unauthorized network activity is being detected then the NIDS 507 may isolate the vulnerable networks or terminate the request. Further, the NIDS 507 or the MMS 511 may cross-validate the contents of the registry files and the master configuration file with the ground system.

According to an embodiment, at step 805, if the NIDS 507 fails to detect any unauthorized network activity, then the NIDS 507 continues to perform the step 801.

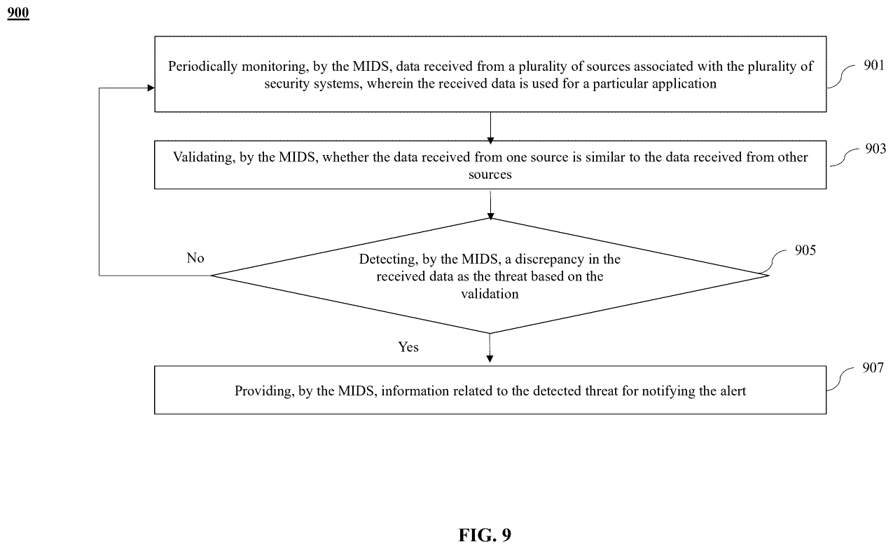

FIG. 9 illustrates a method 900 for detecting malicious input by an MIDS, according to an embodiment of the present disclosure. In an embodiment, the MIDS 509 is uniquely designed hardware or software that is integrated within the avionics system 403. According to some embodiment, the functions of the MIDS 509 can be performed by one or more processors. According to some embodiments, some functions of the MIDS 509 may be deployed and developed with AI-powered solutions for performing specific tasks.

According to an embodiment, the avionics system 403 receives data associated with a security system. These data can be malicious data that can tamper with the original data. For example, data related to pitch angle, and altitude can be tampered with by injecting malicious data. Accordingly, at step 901, the MIDS 509 periodically monitors data received from a plurality of sources associated with the plurality of security systems. As an example, the received data can be used for a particular application like the IRS, EGPWF module, Air Data System, and the like. Further, at step 903, the MIDS 509 validates whether the data received from one source is similar to the data received from other sources. For example, before using the data related to pitch angle or altitude which is received from a first source, the MIDS 509 validates the same with the data related to the pitch angle or the altitude received from the second source. If both data fail to correlate then a threat is detected. Accordingly, at step 905, the MIDS 509 detects whether there is a discrepancy in the received data as the threat based on the validation. In a case, a result of the validation lead to the threat where the MIDS 509 detects that there is a discrepancy then, in such a scenario, at step 907, the MIDS 509 provides information related to the detected threat for notifying the alert. According to an embodiment, the information related to the detected threat may be provided to the MMS 511. Further, the MMS 511 performs the one or more preventive actions in response to the detected threat and also notifies about the alert to at least one of the flight crew and the ground crew.

According to some embodiment, the MIDS 509 may perform the one or more preventive actions in response to the detected threat. Further, the MIDS 509 performs the one or more preventive actions in response to the detected threat and also notifies about the alert to at least one of the flight crew and the ground crew.

For example, in case the malicious data injection is being detected then the MIDS 509 may perform soft rebooting, system recovery operation, or isolate the vulnerable module as a preventive action.

According to an embodiment, at step 905, if the MIDS 509 fails to detect any discrepancy in the received data, then the MIDS 509 continues to perform the step 901.

Accordingly, the disclosed techniques provide comprehensive security measures by implementing a separate security monitor that monitors the processes, file data exchange, network activities, and the like. Further, if there is a deviation from the norm is detected then a potential threat is alerted, and the module(s) may take voluntary responsive actions like rebooting, termination/isolation of the vulnerable process, files, or networks, etc.

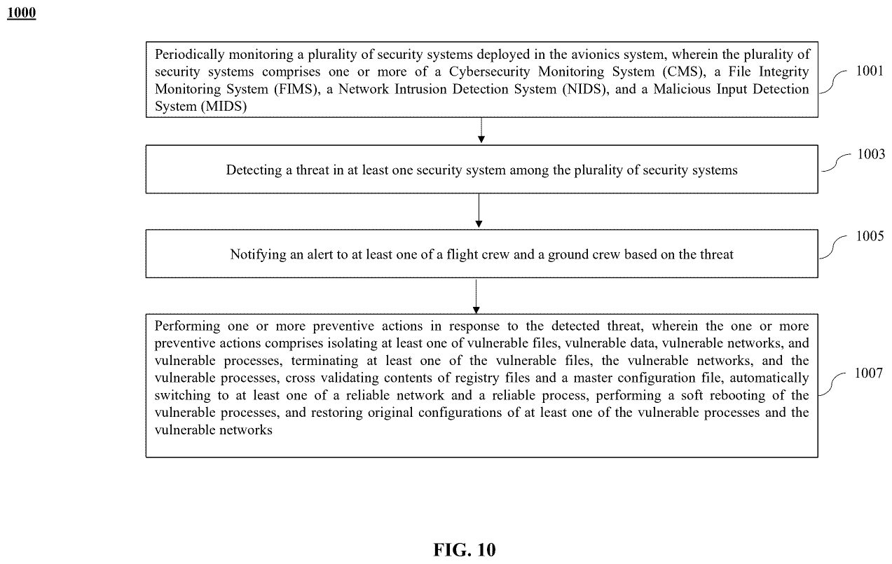

FIG. 10 illustrates a method for implementing security measures in an avionics system of an aircraft, according to an embodiment of the present disclosure. According to an embodiment, the method 1000 is performed by the avionics system 403. The steps are described in FIGS. 4 to 9. Therefore, a detailed description of the same is omitted here.

According to an embodiment, method 1000, at step 1001, includes periodically monitoring the plurality of security systems deployed in the avionics system. The plurality of security systems includes the CMS 503, the FIMS 505, the NIDS 507, and the MIDS 509. In an embodiment, the step 1001 may be performed by the MMS 511.

According to an embodiment, the step 1001 includes that the CMS 503 periodically monitors the data exchange between a plurality of processes, an execution of scheduled processes associated with the plurality of security systems, and the registry files. Further, the CMS 503 validates the data exchange between the plurality of processes using the registry files. Based on the validation, if the CMS 503 detects at least one of the unauthorized process execution and the unauthorized dataflow as the threat, then the CMS 503 provides the information related to the detected threat for notifying the alert to the MMS 511.

According to an embodiment, the step 1001 further includes that the the FIMS 505 periodically monitors the file contents of a plurality of files associated with the plurality of security systems. Further, the FIMS 505 validates the file contents using the master configuration files. Based on the validation, if the FIMS 505 detects at least one of an unauthorized files and discrepancies in the file contents as the threat, then the FIMS 505 provides the information related to the detected threat for notifying the alert to the MMS 511.

According to an embodiment, the step 1001 further includes that the the NIDS 507 periodically monitors a plurality of network activities like a data request, an access request, and a new device connection request. Further, the NIDS 507 validates whether the network activities originated from an authorized IP address using the master configuration files. Based on the validation, if the NIDS 507 detects that the network activities originated from an unauthorized IP address as the threat, then the NIDS 507 provides the information related to the detected threat for notifying the alert to the MMS 511.

According to an embodiment, the step 1001 further includes that MIDS 509 periodically monitors data received from a plurality of sources associated with the plurality of security systems. Further, the MIDS validates whether the data received from one source is similar to the data received from other sources. Further, the MIDS 509 detects a discrepancy in the received data as the threat based on the validation. Further, the MIDS 509 provide information related to the detected threat for notifying the alert to the MMS 511.

According to a further embodiment, the method 100, at step 1003, includes detecting a threat in at least one security system among the plurality of security systems. In an embodiment, the step 1003 can be performed by the MMS 511. Thus, the MMS 511 also detects the threat by using the information related to the detected threat provided by the security systems.

In a further embodiment, the method 100, at step 1005, includes notifying an alert to at least one of a flight crew and a ground crew based on the threat. In an embodiment, the step 1005 can be performed by the MMS 511.

In a further embodiment, the method 100, at step 1007, includes performing one or more preventive actions in response to the detected threat, where the one or more preventive actions includes isolating at least one of vulnerable files, vulnerable data, vulnerable networks, and vulnerable processes, terminating at least one of the vulnerable files, the vulnerable networks, and the vulnerable processes, cross-validating contents of registry files and a master configuration file, automatically switching to at least one of a reliable network and a reliable process, performing a soft rebooting of the vulnerable processes, and restoring original configurations of at least one of the vulnerable processes and the vulnerable networks.

According to a further embodiment, the alert is notified to the flight crew and the ground crew to perform the one or more preventive actions in response to the detected threat.

Accordingly, the disclosed techniques provide comprehensive security measures by implementing a separate security monitor that monitors the processes, file data exchange, network activities, and the like. Further, if there is a deviation from the norm is detected then a potential threat is alerted, and the module(s) may take voluntary responsive actions like rebooting, termination/isolation of the vulnerable process, files, or networks, etc.

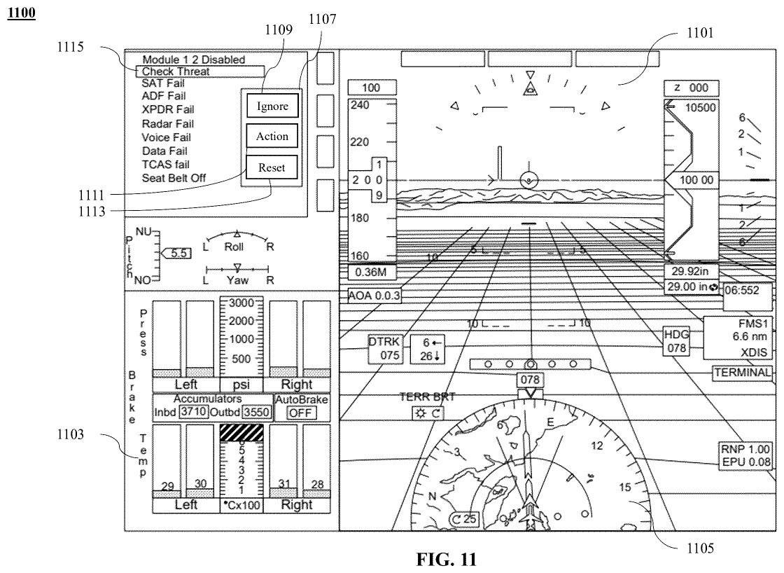

FIG. 11 illustrates an exemplary user interface (UI) for notifying the alert to the pilot or the crew, according to an embodiment of the present disclosure. According to an embodiment, FIG. 11 depicts an exemplary UI 1100, which represents the Primary Flight Display (PFD) of the aircraft 401, which integrates avionics, flight controls, and cybersecurity monitoring systems to provide the pilot and the crew with information related to the aircraft's operational status. The UI 1100 serves as the central hub for pilots to assess flight parameters, system health, and potential security threats, and notifications in real-time.

The UI 1100 may be displayed on the display unit 513. In an embodiment, the UI 1100 depicts various parameters that are used by the avionics system 403. Further, the UI 1100 displays a central section 1101 displaying flight parameters such as altitude, airspeed, heading, and artificial horizon, which are crucial for maintaining safe flight operations. Any tampering with these values could indicate an attempt to mislead the pilots or manipulate the aircraft's control system. The UI 1100 further displays a brake accumulator pressure and a system health indicator. The lower section 1103 provides real-time feedback on the braking system, ensuring safe landing operations. The avionics system 403 ensures that unauthorized modifications to these parameters, such as unexpected pressure loss or unplanned activation of braking mechanisms, are flagged as potential cyber threats.

Additionally, the navigation display (ND) 1105 provides information about a flight path, terrain awareness, proximity alerts, and the like. If the unauthorized data exchanges attempt to alter the navigation path, the avionics system 403 detects the anomaly and alerts the crew before the aircraft 401 deviates from its intended course.

In an embodiment, the UI 1100 on the top left corner area displays possible failures in case of any cyberattacks. For example, the UI 1100 displays satellite failure (SAT Fail), radar failure (RAD fail), voice failure, data failure, and the like. According to an embodiment, in an event of cyberattack, a warning may be displayed on the UI 1100. Further, the flight crew may check the threat by operating upon tab 1115. In an embodiment, the UI 1100 may include an action box 1107 to perform preventive actions by the flight crew. The action box 1107 may include an ignore button 1109, an action button 1111, and a reset action button 1113. The pilot may press the ignore button 1109 to ignore the alert displayed on the UI 1100. Similarly, the pilot may press the action button 1111 to perform preventive actions. Further, the pilot may press the reset action button 1016 to reset any module, process, or avionics cabinet upon receiving the alert on the UI 1000.

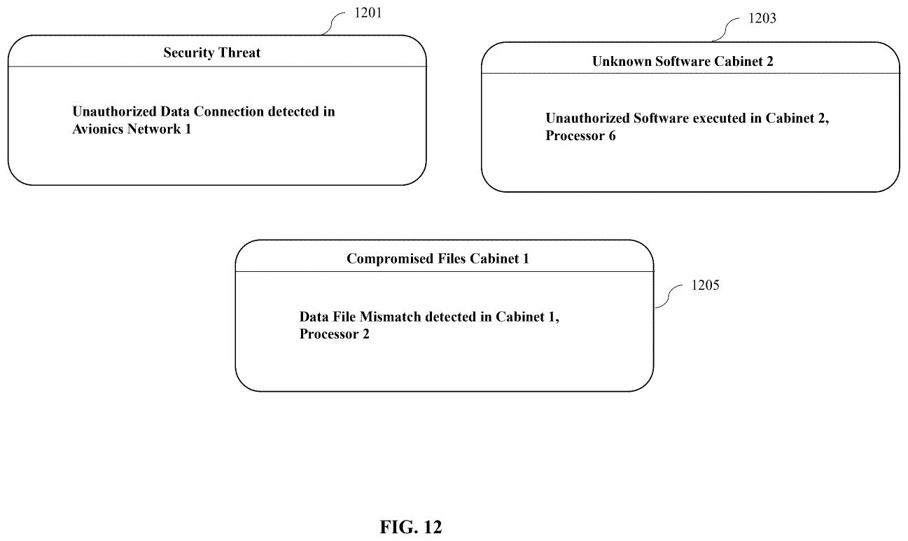

FIG. 12 illustrates an example of notifications displayed on the UI, according to an embodiment of the present disclosure. According to an embodiment, in the event of a threat being detected, the flight crew may receive a notification of the threat or alert on the UI 1100. An example of the notifications are shown in blocks 1201, 1203, and 1205. For example, in case of detection of any security threat, unknown software, or any compromised file, the notifications can be displayed on the UI along with the actions buttons as depicted in the action box 1107. The flight crew may take appropriate action by operating upon any of the buttons of the action box 1107.

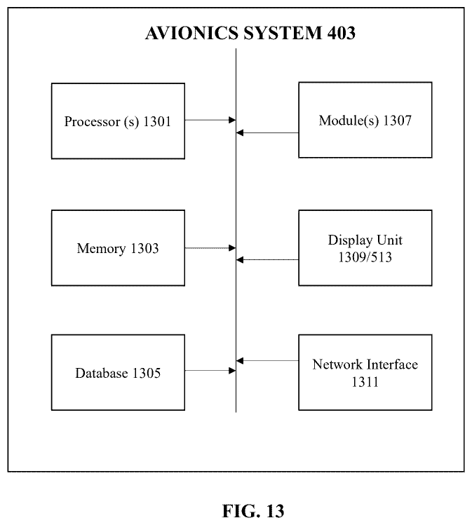

FIG. 13 illustrates a general block diagram of the avionics system, according to an embodiment of the present disclosure.

In an example, the processor(s) 1301 may be a single processing unit or a number of units, all of which could include multiple computing units. The processor(s) 1301 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1301 is configured to fetch and execute computer-readable instructions and data stored in a memory 1303.

The memory 1303 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The processors 1301 may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 1303 may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In an example, the module(s), engine(s), and/or unit(s) 1307 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1307 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 1307 when executed by the processor(s) 1301 may be configured to perform any of the described functionalities.

As a further example, the database 1305 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 1301, and the modules/engines/units.

The modules/engines/units 1307 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 1309/513 includes a computer monitor, a touch screen, an output device capable of displaying the graphics, and the like. The display unit 1209/513 is configured to display visual output in desktops, laptops, and workstations. The display unit 1209/513 may come in different sizes, resolutions, and types (such as LCD, LED, or OLED).

As a further example, the network interface 1311 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for implementing security measures in an avionics system of an aircraft, the method comprises:
periodically monitoring a plurality of security systems deployed in the avionics system, wherein the plurality of security systems comprises one or more of a Cybersecurity Monitoring System (CMS), a File Integrity Monitoring System (FIMS), a Network Intrusion Detection System (NIDS), and a Malicious Input Detection System (MIDS);
detecting a threat in at least one security system among the plurality of security systems;
notifying an alert to at least one of a flight crew and a ground crew based on the threat; and
performing one or more preventive actions in response to the detected threat, wherein the one or more preventive actions comprises:
isolating at least one of vulnerable files, vulnerable data, vulnerable networks, and vulnerable processes,
terminating at least one of the vulnerable files, the vulnerable networks, and the vulnerable processes,
cross-validating contents of registry files and a master configuration file,
automatically switching to at least one of a reliable network and a reliable process,
performing a soft rebooting of the vulnerable processes, and
restoring original configurations of at least one of the vulnerable processes and the vulnerable networks.

2. The method of claim 1, further comprising:
periodically monitoring, by the CMS, data exchange between a plurality of processes, an execution of scheduled processes associated with the plurality of security systems, and the registry files.

3. The method of claim 2, further comprises:
validating, by the CMS, the data exchange between the plurality of processes using the registry files;
detecting, by the CMS, at least one of an unauthorized process execution and unauthorized dataflow as the threat based on the validation; and
providing, by the CMS, information related to the detected threat for notifying the alert.

4. The method of claim 1, further comprising:
periodically monitoring, by the FIMS, file contents of a plurality of files associated with the plurality of security systems.

5. The method of claim 4, further comprising:
validating, by the FIMS, the file contents using the master configuration file;
detecting, by the FIMS, at least one of an unauthorized files and discrepancies in the file contents as the threat based on the validation; and
providing, by the FIMS, information related to the detected threat for notifying the alert.

6. The method of claim 1, further comprising:
periodically monitoring, by the NIDS, a plurality of network activities associated with the plurality of security systems, wherein the plurality of network activities comprises at least one of a data request, an access request, and a new device connection request.

7. The method of claim 6, further comprising:
validating, by the NIDS, whether the network activities are originated from an authorized IP address using the master configuration file;
detecting, by the NIDS, that the network activities are originated from an unauthorized IP address as the threat based on the validation; and
providing, by the NIDS, information related to the detected threat for notifying the alert.

8. The method of claim 1, further comprising:
periodically monitoring, by the MIDS, data received from a plurality of sources associated with the plurality of security systems, wherein the received data is used for a particular application.

9. The method of claim 8, further comprising:
validating, by the MIDS, whether the data received from one source is similar to the data received from other sources;
detecting, by the MIDS, a discrepancy in the received data as the threat based on the validation;
providing, by the MIDS, information related to the detected threat for notifying the alert.

10. The method of claim 1, wherein the alert is notified to the flight crew and the ground crew for performing the one or more preventive actions in response to the detected threat.

11. A system for implementing security measures in an aircraft, comprising:
a plurality of security systems having one or more processors;
a memory; and
one or more programs stored in the memory, the one or more programs when executed by the one or more processors of the plurality of security system cause the one or more processors to:
detect a threat in at least one security system among the plurality of security systems, wherein the plurality of security systems includes one or more of a Cybersecurity Monitoring System (CMS), a File Integrity Monitoring System (FIMS), a Network Intrusion Detection System (NIDS), and a Malicious Input Detection System (MIDS);
notify an alert to at least one of a flight crew and a ground crew based on the threat; and
perform one or more preventive actions in response to the detected threat, wherein the one or more preventive actions comprises:
isolate at least one of vulnerable files, vulnerable data, vulnerable networks, and vulnerable processes,
terminate at least one of the vulnerable files, the vulnerable networks, and the vulnerable processes,
cross-validate contents of registry files and a master configuration file,
automatically switch to at least one of a reliable network and a reliable process,
perform a soft rebooting of the vulnerable processes, and
restore original configurations of at least one of the vulnerable processes and the vulnerable networks.

12. The system of claim 11, wherein the one or more processors are configured to:
periodically monitor data exchange between a plurality of processes, an execution of scheduled processes associated with the plurality of security systems, and the registry files.

13. The system of claim 12, further comprises:
validate the data exchange between the plurality of processes using the registry files;
detect at least one of an unauthorized process execution and unauthorized dataflow as the threat based on the validation; and
provide information related to the detected threat for notifying the alert.

14. The system of claim 11, wherein the one or more processors are configured to:
periodically monitor file contents of a plurality of files associated with the plurality of security systems.

15. The system of claim 14, wherein the one or more processors are configured to:
validate the file contents using the master configuration file;
detect at least one of an unauthorized files and discrepancies in the file contents as the threat based on the validation; and
provide information related to the detected threat for notifying the alert.

16. The system of claim 11, wherein the one or more processors are configured to:
periodically monitor a plurality of network activities associated with the plurality of security systems, wherein the plurality of network activities comprises at least one of a data request, an access request, and a new device connection request.

17. The system of claim 16, wherein the one or more processors are configured to:
validate whether the network activities are originated from an authorized IP address using the master configuration file;
detect that the network activities are originated from an unauthorized IP address as the threat based on the validation; and
provide information related to the detected threat for notifying the alert.

18. The system of claim 11, wherein the one or more processors are configured to:
periodically monitor data received from a plurality of sources associated with the plurality of security systems, wherein the received data is used for a particular application.

19. The system of claim 18, wherein the one or more processors are configured to:
validate whether the data received from one source is similar to the data received from other sources;
detect a discrepancy in the received data as the threat based on the validation;
provide information related to the detected threat for notifying the alert.

20. A non-transitory computer-readable storage medium storing program instructions for implementing security measures in an avionics system of an aircraft, when executed, perform the steps of:
periodically monitoring a plurality of security systems deployed in the avionics system, wherein the plurality of security systems comprises one or more of a Cybersecurity Monitoring System (CMS), a File Integrity Monitoring System (FIMS), a Network Intrusion Detection System (NIDS), and a Malicious Input Detection System (MIDS);
detecting a threat in at least one security system among the plurality of security systems;
notifying an alert to at least one of a flight crew and a ground crew based on the threat; and
performing one or more preventive actions in response to the detected threat, wherein the one or more preventive actions comprises:
isolating at least one of vulnerable files, vulnerable data, vulnerable networks, and vulnerable processes,
terminating at least one of the vulnerable files, the vulnerable networks, and the vulnerable processes,
cross-validating contents of registry files and a master configuration file,
automatically switching to at least one of a reliable network and a reliable process,
performing a soft rebooting of the vulnerable processes, and
restoring original configurations of at least one of the vulnerable processes and the vulnerable networks.
